(19) United States
(12) Patent Application Publication
(10) Pub. No.: US 2014/0132634 A1
(43) Pub. Date: May 15, 2014

(54) Method And Apparatus For Recognizing Target Object At Machine Side in Human-Machine Interaction

(71) Applicant: Tencent Technology (Shenzhen) Company Limited, Shenzhen (CN)

(72) Inventors: Ying WANG, Shenzhen (CN); Shuang QIN, Shenzhen (CN); Chao LIN, Shenzhen (CN); Liucheng ZHANG, Shenzhen (CN); Hao WU, Shenzhen (CN)

(73) Assignee: TENCENT TECHNOLOGY (SHENZHEN) COMPANY LIMITED, Shenzhen (CN)

(21) Appl. No.: 14/160,094

(22) Filed: Jan. 21, 2014

Related U.S. Application Data
(63) Continuation of application No. PCT/CN2012/076596, filed on Jun. 7, 2012.

(30) Foreign Application Priority Data
Jul. 21, 2011 (CN) 201110204966.3

(51) Int. Cl. G06T 11/60; G06K 9/00

(52) U.S. Cl. CPC G06T 11/60; G06K 9/00221
USPC 345/634

(57) ABSTRACT

An apparatus which includes a first displaying module to display the target picture, a graphic tag superimposing module to superimpose a graphic tag on a target object in the target picture according to an instruction sent by a user and determine a display parameter of the graphic tag, an identifier information adding module to add identifier information for the graphic tag, a storage controlling module to store the display parameter of the graphic tag and the identifier information of the graphic tag in a storage medium related to the target picture, and a second displaying module to obtain the display parameter and the identifier information from the storage medium related to the target picture, display the graphic tag on the target object in the target picture according to the display parameter of the graphic tag, and display the identifier information of the graphic tag.

### CROSS-REFERENCE TO RELATED APPLICATIONS

This application is a continuation of International Application No. PCT/CN2012/076596, filed on Jun. 7, 2012. This application claims the benefit and priority of Chinese Patent Application No. 201110204966.3, filed on Jul. 21, 2011. The entire disclosures of each of the above applications are incorporated herein by reference.

### FIELD

The present disclosure relates to human-machine interaction technologies and to a method and apparatus for recognizing a target object at a machine side in human-machine interaction.

### BACKGROUND

This section provides background information related to the present disclosure which is not necessarily prior art.

Currently, in various Internet services providing human-machine interaction services, e.g., virtual community services, a target object is always identified by using pure characters at a machine side. The target object may be a certain person or a certain thing, and the certain person is taken as an example in the following descriptions. For example, a certain person may be identified by combining a specific symbol with a name or designation, so as to quickly locate an information page of the person or provide other human-machine interaction operations. However, the Internet provided by the machine side includes texts and a lot of picture data. The certain person or certain thing is increasingly represented by using a picture. The following problems are caused when the target object is still identified by using pure characters.

The characters for recognizing the target object cannot be associated with a picture including the target object. For example, when the user wants to recognize a person from a picture of the machine side, the user needs to search text introduction page related to the picture and then determine or presume who is the person in the picture. On the one hand, the information provided by the machine side is monotonous and it is not convenient for the user to recognize a certain target object from vast amounts of text data and picture data at the machine side. In most cases, the user cannot recognize the target object from the pictures successfully, hence human-machine interaction experiences of the user is bad. On the other hand, the user has to perform more human-machine interaction operations to obtain more text information to recognize the target object from the pictures. Each human-machine interaction operation includes sending request information, triggering a compute procedure and generating response information, and thus a great deal of resources at the machine side, e.g., client resources, server resources and network bandwidth resources are occupied. Especially, when one picture includes multiple target objects, e.g., the picture includes multiple persons, the procedure of recognizing the person by using the pure characters is more complicated, and more human-machine interaction operations are necessary and more resources at the machine side are occupied.

### SUMMARY

This section provides a general summary of the disclosure, and is not a comprehensive disclosure of its full scope or all of its features.

Various embodiments provide a method and apparatus for recognizing a target object at a machine side in human-machine interaction, so that it is convenient for a user to recognize a target object from a picture and reduce occupancy of resources at the machine side.

The technical solutions of the present disclosure are implemented as follows.

A method for recognizing a target object at a machine side in human-machine interaction, applied to recognize a target object in a target picture at a machine side includes: recognizing processing and displaying processing;

the recognizing processing comprises:

superimposing a graphic tag on a target object in a target picture displayed according to an instruction sent by a user, determining a display parameter of the graphic tag;

adding identifier information for the graphic tag;

storing the display parameter of the graphic tag and the identifier information of the graphic tag in a storage medium related to the target picture;

the displaying processing comprises:

obtaining the display parameter of the graphic tag and the identifier information of the graphic tag from the storage medium related to the target picture;

displaying the graphic tag on the target object in the target picture according to the display parameter of the graphic tag; and

displaying the identifier information of the graphic tag.

An apparatus for recognizing a target object at a machine side in human-machine interaction includes:

a first displaying module, configured to display a target picture;

a graphic tag superimposing module, configured to superimpose a graphic tag on a target object in the target picture according to an instruction sent by a user; and determine a display parameter of the graphic tag;

an identifier information adding module, configured to add identifier information for the graphic tag;

a storage controlling module, configured to store the display parameter of the graphic tag and the identifier information of the graphic tag in a storage medium related to the target picture; and

a second displaying module, configured to obtain the display parameter of the graphic tag and the identifier information of the graphic tag from the storage medium related to the target picture; display the graphic tag on the target object in the target picture according to the display parameter of the graphic tag; and display the identifier information of the graphic tag.

A non-transitory computer readable storage medium stores computer program for executing the above method.

According to the solutions of the present disclosure, the target object is recognized by using the graphic tag on the target picture displayed at the machine side, and the identifier information is added, so that the identifier information of the target object is associated with the picture including the target object, so as to make it convenient for the user to recognize the target object from the picture, and reduce the number of human-machine interaction operations, thereby reducing occupancy of resources at the machine side and facilitating the operation of the user.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flowchart illustrating a method according to various embodiments.

FIGS. 2a to 2k depict interfaces of “circling a person” according to various embodiments.

FIG. 3 depicts an apparatus according to various embodiments.

FIG. 4 depicts an apparatus according to various embodiments.

Corresponding reference numerals indicate corresponding parts throughout the several views of the drawings.

### DETAILED DESCRIPTION

Example embodiments will now be described more fully with reference to the accompanying drawings.

The following description is merely illustrative in nature and is in no way intended to limit the disclosure, its application, or uses. The broad teachings of the disclosure can be implemented in a variety of forms. Therefore, while this disclosure includes various embodiments, the true scope of the disclosure should not be so limited since other modifications will become apparent upon a study of the drawings, the specification, and the following claims.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the terms “comprising,” “including,” “having,” “containing,” “involving,” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term “shared”, as used herein, means that some or all code from multiple modules may be executed using a single (shared) processor. In addition, some or all code from multiple modules may be stored by a single (shared) memory. The term “group”, as used herein, means that some or all code from a single module may be executed using a group of processors. In addition, some or all code from a single module may be stored using a group of memories.

The systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

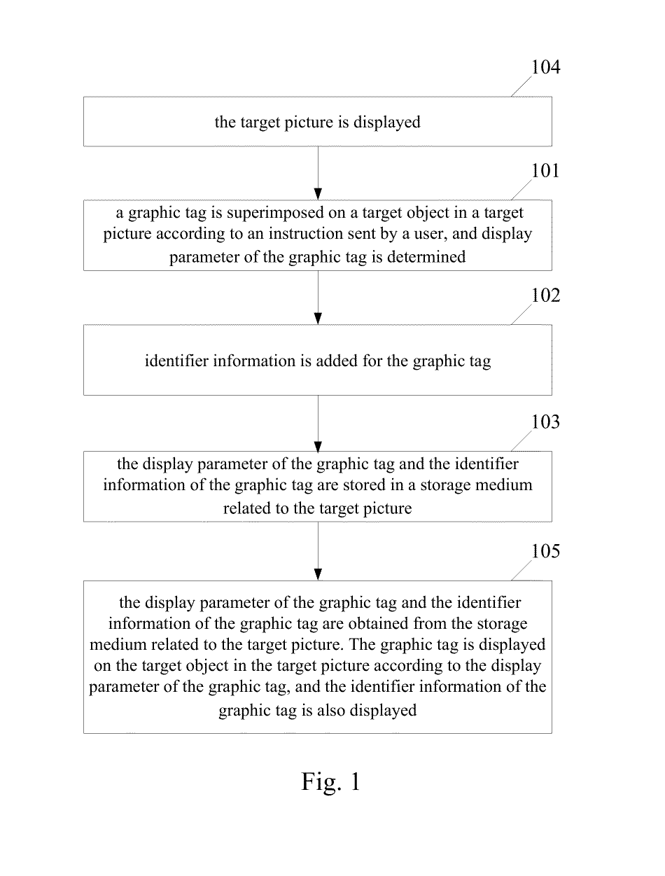

The description will be made as to the various embodiments in conjunction with the accompanying drawings in FIGS. 1-4. It should be understood that specific embodiments described herein are merely intended to explain the present invention, but not intended to limit the present invention. In accordance with the purposes of this invention, as embodied and broadly described herein, this invention, in one aspect, relates to method and apparatus for recognizing a target object at a machine side in human-machine interaction.

Examples of mobile terminals that can be used in accordance with various embodiments include, but are not limited to, a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), or an on-vehicle device running any of the above-mentioned operating systems or any other operating systems, all of which are well known to one skilled in the art.

FIG. 1 is a flowchart illustrating a method according to various embodiments. As shown in FIG. 1, in the method, a target object is recognized in a target picture at a machine side, and recognizing processing and displaying processing are included.

The recognizing processing is as follows.

At 101, a graphic tag is superimposed on a target object in a target picture according to an instruction sent by a user. In the example, the graphic tag may be any graphic, e.g., a rectangle or a circle. A display parameter of the graphic tag is determined. The display parameter may include a size of the graphic tag and location coordinates of the graphic tag on the target picture.

At 102, identifier information is added for the graphic tag. The identifier information may be generated according to an instruction sent by the user. The identifier information may be an identifier of the target object, e.g., a name or a code name, or comment information corresponding to the target object, so as to implement a local comment function.

At 103, the display parameter of the graphic tag and the identifier information of the graphic tag are stored in a storage medium related to the target picture.

The displaying processing is as follows.

At 104, the target picture is displayed.

According to various embodiments, the processing at 104 may be performed before the recognizing processing.

At 105, the display parameter of the graphic tag and the identifier information of the graphic tag are obtained from the storage medium related to the target picture. The graphic tag is displayed on the target object in the target picture according to the display parameter of the graphic tag, and the identifier information of the graphic tag is also displayed.

For the purpose of improving interactivity, in various embodiments, the following operations are included in the displaying processing. A comment prompt box is displayed, and comment information submitted by a user having comment permission is received. The comment information is stored in the storage medium related to the target picture, and the comment information is displayed in a web page related to the target picture. The web page related to the target picture may be, e.g., a home information center interface of a user having permission to interact with the recognized target object or a details page of the target picture. The user having the comment permission includes the user sending the instruction in the recognizing processing at 101, an owner of the target picture, the target object recognized in the target picture, a friend of the target object, etc.

For the purpose of implementing a function of obtaining pictures based on person information, in various embodiments, the method further includes the following process. Whether at least two target pictures are superimposed with graphic tags and identifier information of the graphic tags are identical is determined. If at least two target pictures are superimposed with graphic tags and identifier information of the graphic tags are identical, e.g., the same name of a person is added for two graphic tags superimposed on two target pictures respectively, all of the target pictures corresponding to the same identifier information are stored or displayed as a category of target pictures, and the identifier information is taken as identifier information of the category of the target pictures. Therefore, it is convenient for the user to view the target pictures including the same target object.

According to various embodiments, the graphic tag is a geometric pattern and thus may overlap with other graphic tag. Hence, when more than one target object (e.g., persons) are included in one picture, each target object may be recognized and identifier information may be added for each target object. When the target picture includes more than one target object, processing at 101, 102, and 103 are performed for the more than one target object according to instructions of the user respectively, and the graphic tags and the identifier information of the more than one target object are displayed on the target picture.

Further, for the purpose of leading the user to perform recognizing processing by using both the picture and the text, before receiving the instruction from the user, whether there is a face target object is recognized, and a graphic tag is superimposed on the face target object if there is the face target object.

In the following embodiment, the method is implemented in an Internet virtual community at machine side. A target picture may be stored in any web page capable of displaying a picture in the Internet virtual community at the machine side, e.g., an album page, a “talk” page, a share page, picture content in a blog, etc. The “talk” page is a web page for describing mood of a user and may include texts, pictures, video, etc. The target object in the target picture may be a person, e.g., a friend or a classmate of the current user, or a celebrity followed by the current user. The target object may be a thing, e.g., a certified space. The certified space may be a network space that provides more specific functions for famous brands, agencies, media, and celebrities. The person in the target picture is recognized, and operations of recognizing the person in the target picture are called “circling a person”.

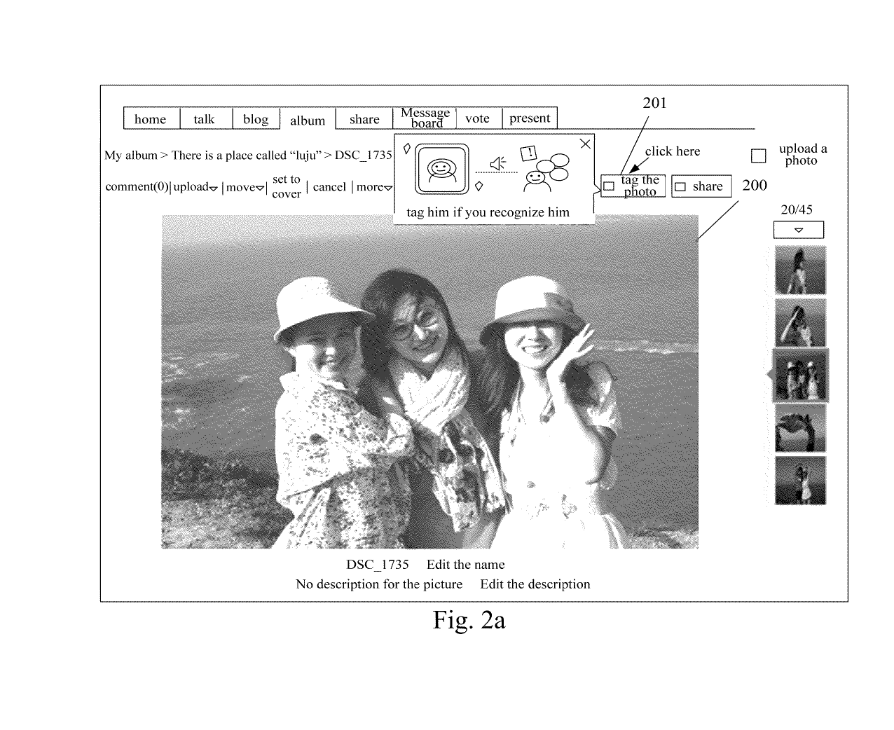

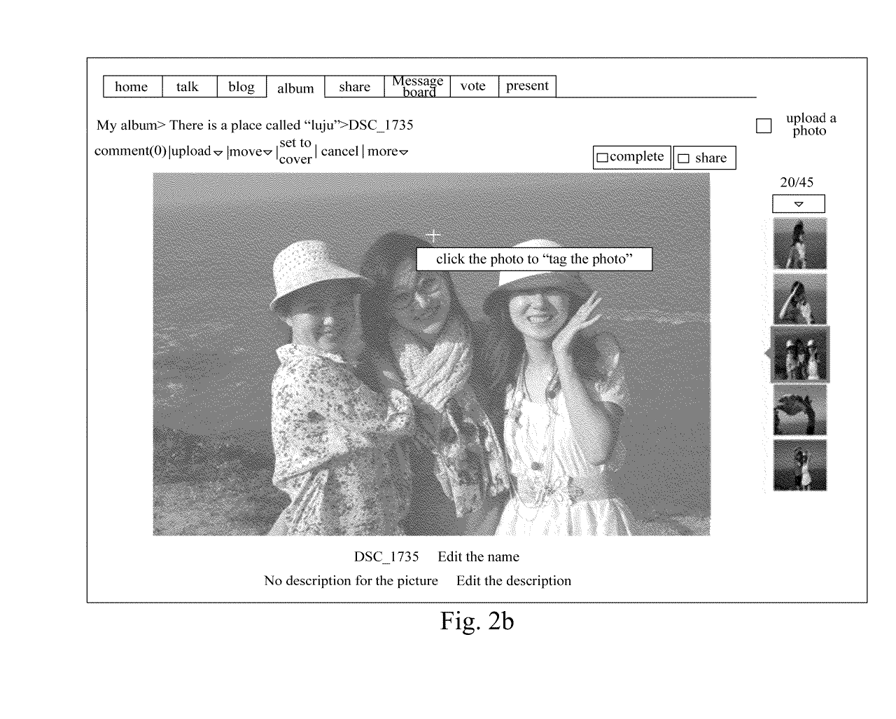

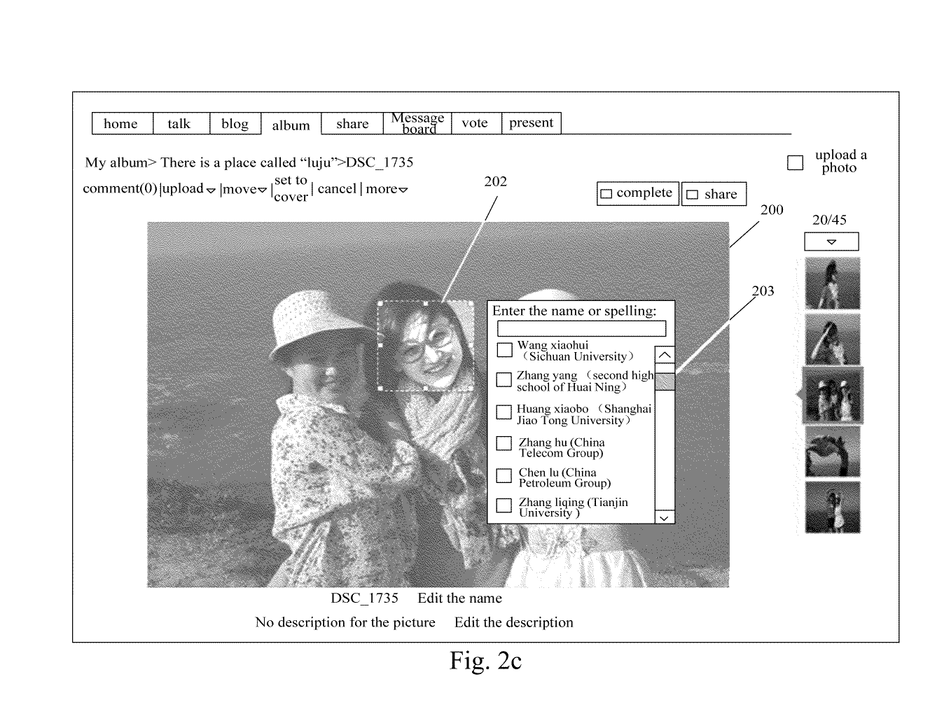

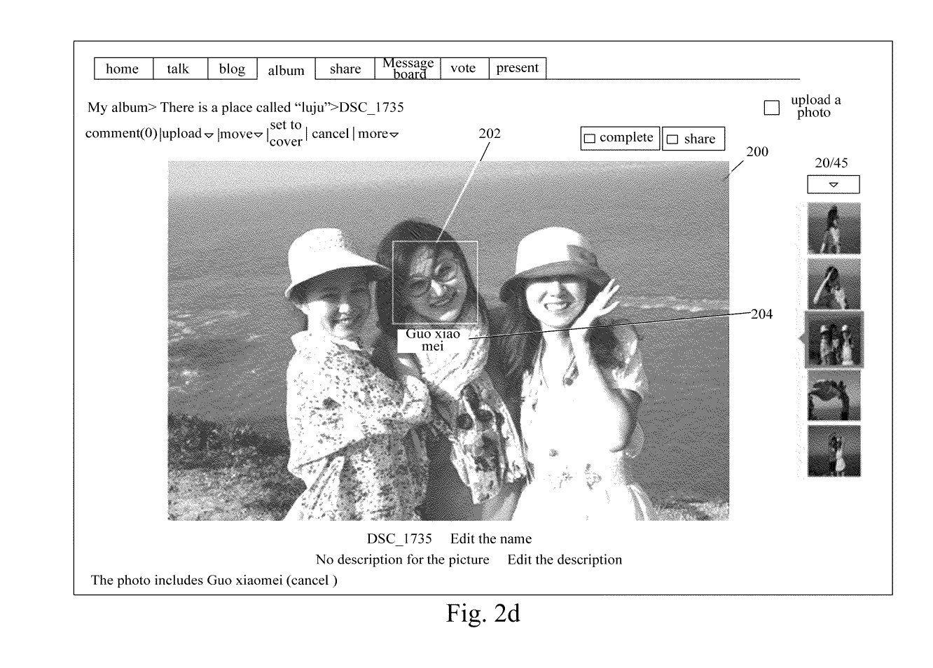

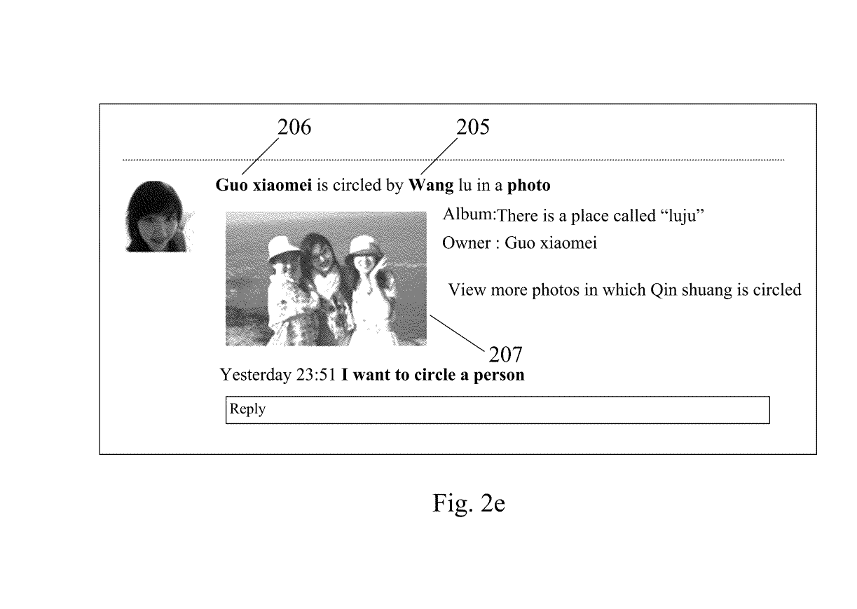

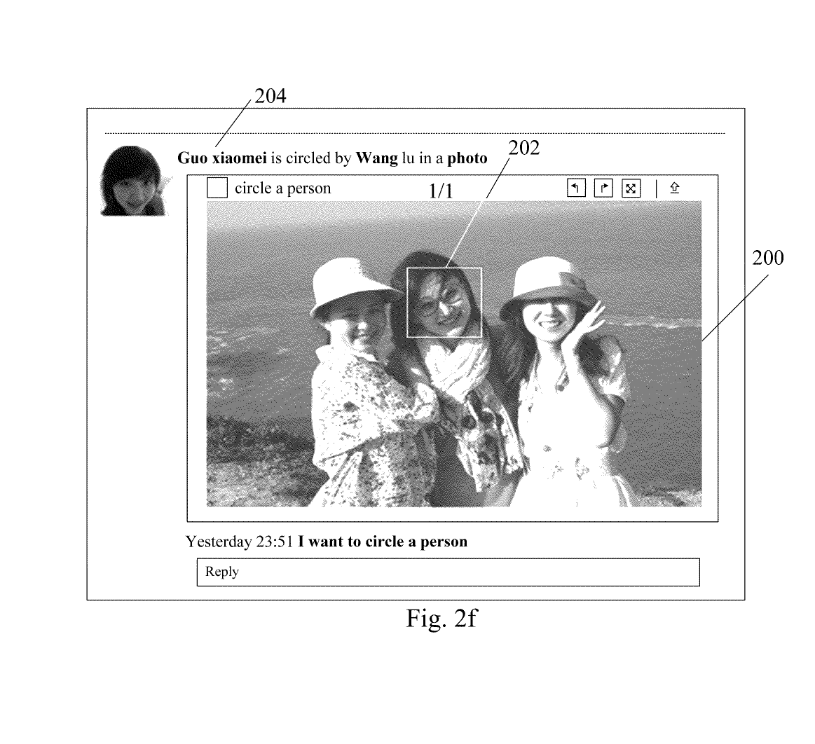

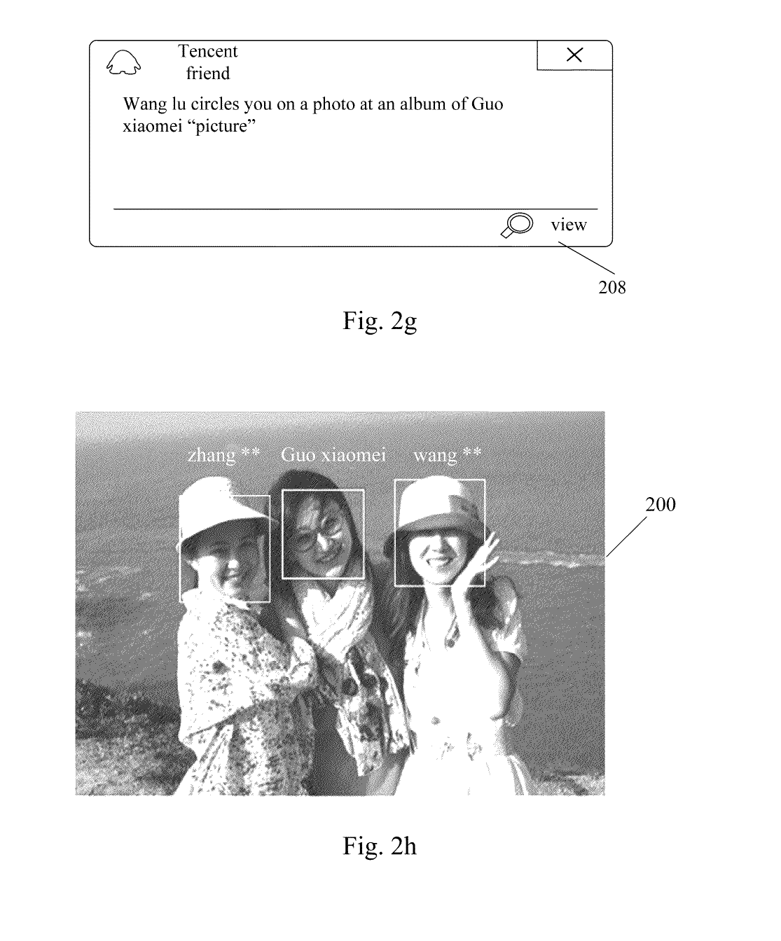

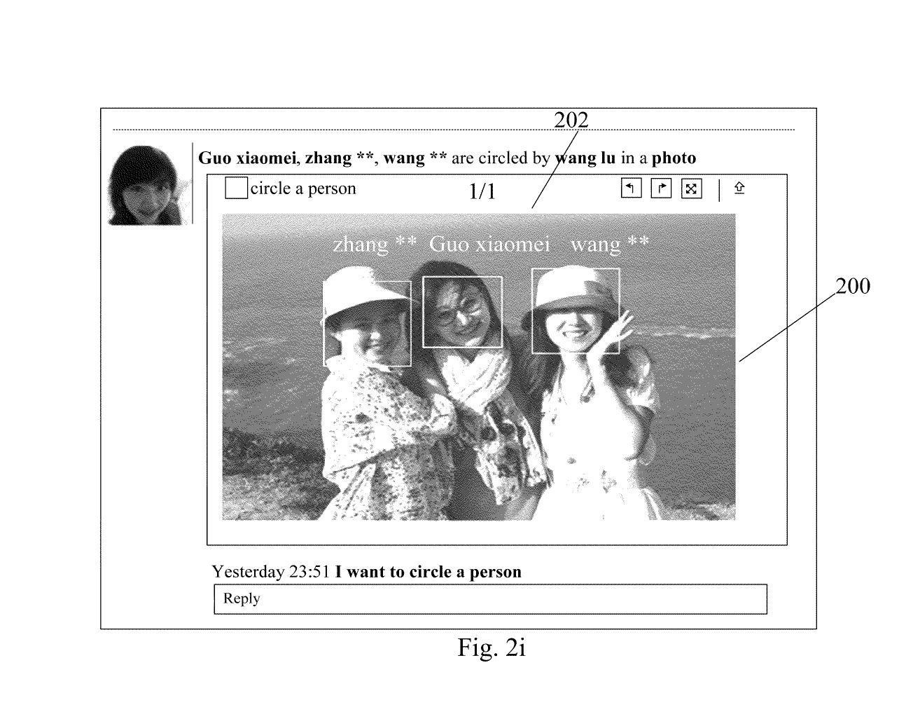

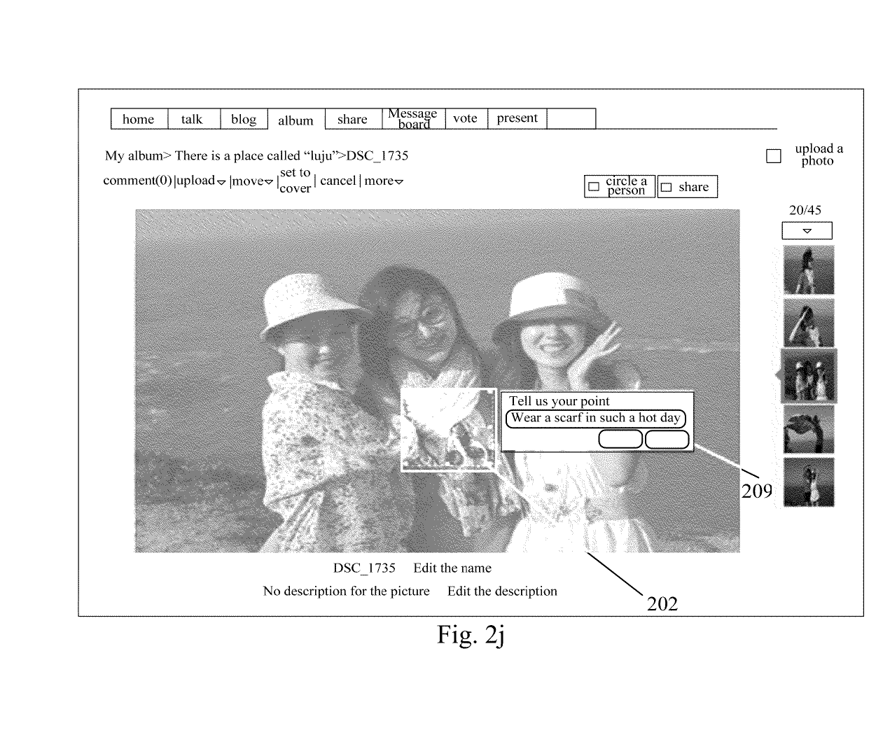

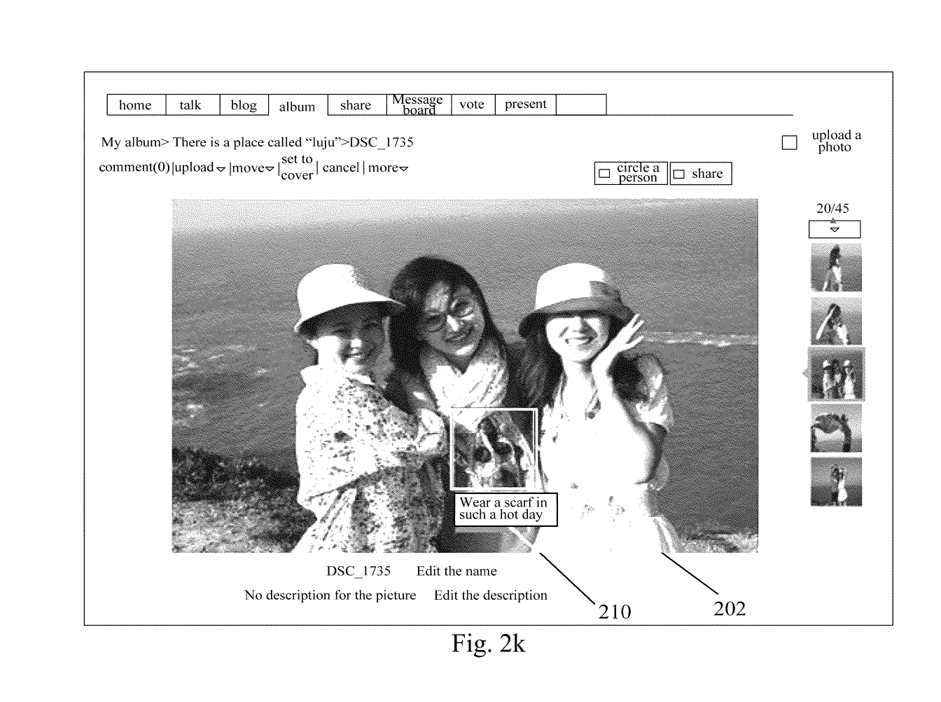

FIGS. 2a to 2k depict interfaces of “circling a person” according to various embodiments.

Operations of “circling person” include processing as shown in FIGS. 2a to 2d.

At (11), as shown in FIG. 2a, on an information center page or a photo details page of the virtual community album, a “circling a person” button 201 is clicked by a user, and an instruction is sent to the machine side, so as to request an operation interface to perform the “circling a person” operations for a person in a target picture 200. According to various embodiments, permission to perform the “circling a person” operations may be configured on a specific permission configuration page. The user may configure whether the “circling a person” operation is allowed to be performed for the album, whether the “circling a person” operation needs a second confirmation, persons that will be shown the target picture, etc.

At (12), as shown in FIG. 2b, when the target picture is in a gray status, the user may drag the mouse on the target picture or click a location needed to be circled on the target picture, so as to send a recognizing instruction to the machine side for recognizing a certain target object by superimposing a graphic tag. As shown in FIG. 2c, a graphic tag 202 of a rectangular shape is superimposed on the target picture 200, and a target object is recognized, i.e., the target object is a person in the middle of the picture. The graphic tag 202 of other shapes may be used, e.g. a circular shape, an elliptic shape, etc. The size and the location of the graphic tag 202 may be adjusted according to operation instructions of the user. After the adjustment is completed and confirmed, display parameter of the graphic tag 202 may be determined. According to various embodiments, the display parameter may include the size of the graphic tag 202 and coordinates of the graphic tag 202 on the target picture 202.

At (13), as shown in FIG. 2c, after the display parameter of the graphic tag 202 is determined, identifier information of the graphic tag is added. The identifier information may be object identifier information, e.g., a name of a person, which may be configured by using a friend selector. In FIG. 2c, a friend selector 203 of the user sending the recognizing instruction is shown. The friend selector 203 displays information of users having permission to interact with the user sending the recognizing instruction, e.g., friends, classmates, followed celebrities or certified space users. The friend selector 203 may display identifier information of these users, e.g., avatars, names, schools or company names, so as to facilitate selecting a certain user. The identifier information of the selected user may be taken as the identifier information of the graphic tag corresponding to target object.

In addition, according to various embodiments, a leading function for adding friends is implemented. When a name input into the friend selector does not corresponding to any friend, classmate, or followed celebrity, the user is prompted to input an account of the user. After the account of the user is verified by a system at the machine side, the user may perform operations for adding a friend.

At (14), as shown in FIG. 2d, after adding the identifier information 204, e.g., the name of the friend, the operations of “circle a person” is finished. The user may send a finish instruction. At the machine side, the display parameter of the graphic tag 202 and the identifier information 204 are stored in a storage medium related to the target picture 200. The storage medium related to the target picture 200 may be a storage medium for storing the target picture, e.g., a local storage server, or may be a storage medium located at a network side. The storage medium located at the network side needs to be associated with the target picture.

Further, there is a procedure of displaying the target picture, and a procedure of notifying the “circling a person” operations is included. According to various embodiments, at least one of the following processing as shown in FIG. 2e to FIG. 2g may be included.

At (21), dynamic information is generated in the name of the recognized target object to indicate the recognizing processing. The dynamic information is displayed on a web page of a user having permission to interact with the target object, e.g., friends, classmates and followed users. For example, the dynamic information may be displayed on an information center page. The user having the permission to interact with the target object may view the dynamic information corresponding to the identified target object.

As show in FIG. 2e, the dynamic information includes the name of the user performing the “circling a person” operation 205, the name of the target object 206, and a thumbnail of the target picture 207. After the thumbnail is clicked, a normal picture is displayed, as shown in FIG. 2f. According to various embodiments, the target picture 200 is displayed first. The display parameter of the graphic tag and the identifier information of the graphic tag are obtained from storage medium related to the target picture, and the graphic tag 202 is displayed on the target object in the target picture according to the display parameter of the graphic tag, and identifier information 204 of the graphic tag is also displayed. In various embodiments, the identifier information 204 may be displayed near the graphic tag 202 on the target picture, e.g., the location of the identifier information 204 as shown in FIG. 2d.

At (22), a dynamic notification is sent to the recognized target object, e.g., the circled person, and an owner of the target picture, e.g., an owner of the photo. The dynamic notification is a notification directly sent to the receiver and is displayed on a page window no matter whether the receiver wants to receive the notification, as shown in FIG. 2g. The dynamic notification is used to indicate the recognizing processing. When a view button 208 of the dynamic notification is clicked, a normal picture is displayed, as shown in FIG. 2f. According to various embodiments, the target picture 200 is displayed first. The display parameter of the graphic tag and the identifier information of the graphic tag are obtained from storage medium related to the target picture, and the graphic tag 202 is displayed on the target object in the target picture according to the display parameter of the graphic tag, and identifier information 204 of the graphic tag is also displayed.

Finally, interaction comment may be provided for the recognized target object in the target picture.

A comment prompt box is displayed. Comment information submitted by a user having comment permission is received. The user having comment permission may be the user performing the “circling a person” operations, the owner of the photo, the target object, or the friend of the target object. The comment information is stored in the storage medium related to the target picture and is displayed in a web page related to the target picture. The web page related to the target picture may be, e.g., a home information center interface of the user having permission to interact with the target person, or a details page of the target picture.

According to various embodiments, when a certain user sends comment information, a message is triggered at the “talk” page, and all items of the comment information are stored in the details page of the target picture.

Further, since the target picture 200 includes more than one target object, i.e., three persons, the user may perform the “circling a person” operations as shown in FIG. 2a to FIG. 2d repeatedly, and two or three persons may be recognized. In the displaying processing, graphic tags corresponding to the more than one target object and identifier information of each of the graphic tags are displayed on the target picture 200, as shown in FIG. 2h.

In addition, when more than one friend of the user are recognized on the same photo, the dynamic information is sent in the name of the user recognized last, as shown in FIG. 2e, and the object identifier information corresponding to other recognized friends is displayed together, as shown in FIG. 2i.

Moreover, each time when the user recognizes the person, the system may store the target pictures corresponding to the same object identifier information together, that is, all of the photos in which the same user is recognized are display together, so that a function of obtaining pictures based on person information is implemented and better expansibility of community-based interaction is achieve.

According to various embodiments, the “circling a person” operations may be applied for many scenes. Besides the album of the user and the album of the friend of the user, the user may also perform the “circling a person” operations on the “talk” page, the blog page, or the shared picture.

According to various embodiments, the “circling a person” operations may be applied for many objects. Besides the friend and classmate of the user, the “circling a person” operations may be performed for the celebrity followed by the user or certified space. If the user does not have the permission to recognize a person, the user may send a request for adding the person as a friend.

In addition, according to various embodiments, when the user uploads a photo or views a photo, if the user does not trigger the “circling a person” operation directly, whether there is a face target object may be determined by recognizing a face of a person according to face recognition technologies. If the photo includes the face target object, a graphic tag is superimposed on the face target object in the photo, so as to lead the user to perform the “circling a person” operations. The face recognition technology may be any conventional technologies.

In the above embodiment, the identifier information added for the graphic tag is the object identifier information, e.g., the name of the person.

According to various embodiments, the identifier information may be comment information, as shown in FIG. 2j. After the graphic tag 202 is superimposed on the target object, a comment input box 209 is directly displayed beside the graphic tag 202 and comment information may be input. After the comment information is input and a confirmation instruction is received, in the displaying procedure, comment information 210 is taken as the identifier information and is displayed beside the graphic tag 202, as shown in FIG. 2k, or the comment information 210 may be displayed at another location of the web page. According to various embodiments, the function of providing comment for part of the target picture is implemented.

After the user provides comments for a certain target picture, a dynamic notification similar with the dynamic notification at (22) is sent to the owner of the target picture. The dynamic notification is directly sent to the receiver in a one-to-one mode. The dynamic notification is used for indicating the operations of the recognizing process, i.e., the common operations for part of the target picture. The dynamic notification includes a thumbnail and comment information for part of the target picture. After the thumbnail is clicked, a normal picture is displayed.

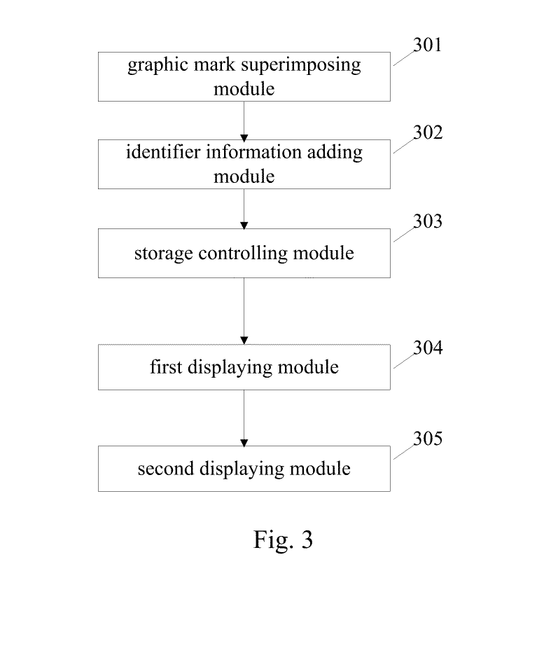

According to various embodiments, an apparatus for recognizing a target object at a machine side in human-machine interaction is provided. FIG. 3 is a schematic diagram illustrating an apparatus according to various embodiments. As shown in FIG. 3, the apparatus includes a graphic tag superimposing module 301, an identifier information adding module 302 and a storage controlling module 303, a first displaying module 304 and a second displaying module 305.

The graphic tag superimposing module 301 superimposes a graphic tag on a target object in a target picture according to an instruction sent by a user, and determines a display parameter of the graphic tag.

The identifier information adding module 302 adds identifier information for the graphic tag.

The storage controlling module 303 is to store the display parameter of the graphic tag and the identifier information of the graphic tag in a storage medium related to the target picture.

The first displaying module 304 displays the target picture.

The second displaying module 305 obtains the display parameter of the graphic tag and the identifier information of the graphic tag from the storage medium related to the target picture, displays the graphic tag on the target object in the target picture according to the display parameter of the graphic tag, and displays the identifier information of the graphic tag.

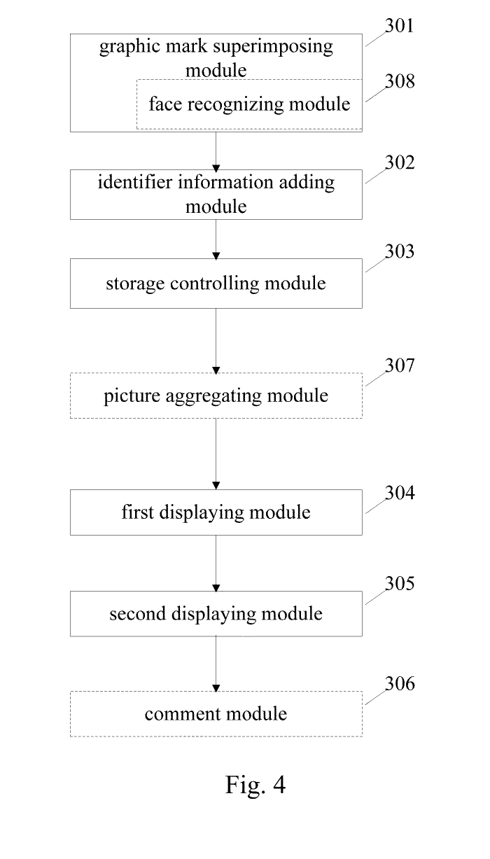

FIG. 4 is a schematic diagram illustrating an apparatus according to various embodiments.

Besides the components in the embodiment shown in FIG. 3, the apparatus further includes a comment module 306. The comment module 306 displays a comment prompt box, receives comment information submitted by a user having comment permission; stores the comment information in the storage medium related to the target picture; and displays the comment information in a web page related to the target picture.

The apparatus may further include a picture aggregating module 307. The picture aggregating module 307 determines whether at least two target pictures are superimposed with graphic tags and identifier information of the graphic tags are identical. If at least two target pictures are superimposed with graphic tags and identifier information of the graphic tags are identical, the picture aggregating module 307 stores or displays the at least two target pictures as a category of target pictures, and takes the identifier information as identifier information of the category of the target pictures.

The graphic tag superimposition module 301 further includes a face recognizing module 308. The face recognizing module 308 recognizes whether there is a face target object before the instruction sent by the user is received, superimposing a graphic tag on the face target object if there is the face target object.

Each embodiment may be implemented by data processing program executed by a data processing device, e.g., a computer. The data processing program is included in various embodiments. Generally the data processing program stored in storage medium may directly read a program from the storage medium, or may install or copy the program to a storage device of the data processing device (e.g., a hard disk or memory). Thus, the storage medium is included in the various embodiments. The storage medium may use any recording mode, e.g., page storage medium (e.g., tape), magnetic storage media (e.g., floppy disks, hard disks, flash), optical storage medium (e.g., CD-ROM), or magnetic-optical storage medium (e.g., MO).

According to various embodiments, a storage medium is also provided, which stores data processing program to cause a machine to execute a method as described herein.

According to the solutions of the present disclosure, the target object is recognized by using the graphic tag on the target picture displayed at the machine side, and the identifier information is added, so that the identifier information of the target object is associated with the picture including the target object, so as to make it convenient for the user to recognize the target object from the picture, and reduce the number of human-machine interaction operations, thereby reducing occupancy of resources at the machine side and facilitating the operation of the user.

Further, comments may be provided after the target object of the target picture is recognized by using the graphic tag. The comment information input by the related user may be stored and displayed. In addition, the identifier information added for the graphic tag may be comment information, so that multiple comments from multiple users for the target object are gathered. Therefore, the user may provide comment information for part of the picture and interactivity is improved, related information of the target object is enriched, and the user may obtain more information of the target object from the same web page. In addition, all of the target pictures corresponding to the same identifier information are stored and display together, it is convenient for the user to view the target pictures corresponding to the same target object. According to the above solutions, the number of human-machine interaction operations for searching for related information of the target object is reduced, and occupancy of resources at the machine side is reduced.

Moreover, since the graphic tag may be overlap with other graphic tags, when the picture includes more than one target object, each target object may be recognized and descriptions are added respectively, so that it is easy for the user to recognize a certain target object from the picture including more than one target object, thereby further facilitating the operation of the user.

When the solutions of the present disclosure are applied for Internet services providing multiple human-machine services, e.g., the virtual community service, interactivity between persons are improved, it is easy to the user to obtain more intuitive information, the pure text interaction is replaced by parallel text-graphic interaction, and less resources are occupied to exchange more information.

The methods and modules described herein may be implemented by hardware, machine-readable instructions or a combination of hardware and machine-readable instructions. Machine-readable instructions used in the various embodiments disclosed herein may be stored in storage medium readable by multiple processors, such as hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD, specific-purpose computers, and so on.

A machine-readable storage medium is also provided, which stores instructions to cause a machine to execute a method as described herein. Specifically, a system or apparatus having a storage medium that stores machine-readable program codes for implementing functions of any of the above embodiments and that may make the system or the apparatus (or CPU or MPU) read and execute the program codes stored in the storage medium.

In this situation, the program codes read from the storage medium may implement any one of the above embodiments, thus the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM, and so on. Optionally, the program code may be downloaded from a server computer via a communication network.

It should be noted that, alternatively to the program codes being executed by a computer, at least part of the operations performed by the program codes may be implemented by an operation system running in a computer following instructions based on the program codes to realize a technical scheme of any of the above embodiments.

In addition, the program codes implemented from a storage medium are written in a storage in an extension board inserted in the computer or in a storage in an extension unit connected to the computer. In various embodiments, a CPU in the extension board or the extension unit executes at least part of the operations according to the instructions based on the program codes to realize a technical scheme of any of the above embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for recognizing a target object at a machine side in human-machine interaction, applied to recognize a target object in a target picture at a machine side, comprising: recognizing processing and displaying processing; wherein
the recognizing processing comprises:
superimposing a graphic tag on a target object in a target picture displayed according to an instruction sent by a user, determining a display parameter of the graphic tag;
adding identifier information for the graphic tag;
storing the display parameter of the graphic tag and the identifier information of the graphic tag in a storage medium related to the target picture;
the displaying processing comprises:
obtaining the display parameter of the graphic tag and the identifier information of the graphic tag from the storage medium related to the target picture;
displaying the graphic tag on the target object in the target picture according to the display parameter of the graphic tag; and
displaying the identifier information of the graphic tag.

2. The method of claim 1, wherein the displaying processing further comprises:
displaying a comment prompt box;
receiving comment information submitted by a user having comment permission;
storing the comment information in the storage medium related to the target picture; and
displaying the comment information in a web page related to the target picture.

3. The method of claim 2, wherein the user having comment permission comprises the user sending the instruction in the recognizing processing, an owner of the target picture, the target object in the target picture, and a friend of the target object.

4. The method of claim 1, further comprising:
determining whether at least two target pictures are superimposed with graphic tags and identifier information of the graphic tags are identical;
if at least two target pictures are superimposed with the graphic tags and the identifier information of the graphic tags are identical, storing or displaying the at least two target pictures as a category of target pictures, and taking the identifier information as identifier information of the category of the target pictures.

5. The method of claim 1, further comprising:
when the target picture comprises at least two target objects,
performing the recognizing processing for each of the at least two target objects according to instructions of the user respectively;
displaying graphic tags corresponding to the at least two target objects and identifier information of the graphic tags on the target picture, in the displaying processing.

6. The method of claim 1, further comprising:
before the instruction sent by the user is received in the recognizing processing,
recognizing whether there is a face target object;
superimposing a graphic tag on the face target object, if there is the face target object.

7. The method of claim 1, wherein the identifier information comprises object identifier information or comment information.

8. The method of claim 1, wherein the identifier information is the object identifier information; and
the method further comprises:
after the recognizing processing and before the displaying processing,
generating dynamic information in the name of the target object to indicate the recognizing processing; the dynamic information being displayed on a web page of a user having permission to interact with the target object; the dynamic information comprising a thumbnail of the target picture;
wherein the displaying processing is performed after the thumbnail is clicked.

9. The method of claim 1, wherein the identifier information is the object identifier information; and
the method further comprises:
after the recognizing processing and before the displaying processing,
sending a dynamic notification to the target object and an owner of the target picture to indicate the recognizing processing;
wherein the displaying processing is performed after the dynamic notification is viewed.

10. The method of claim 1, wherein the identifier information is the comment information; and
the method further comprises:
after the recognizing processing and before the displaying processing, sending a dynamic notification in the name of an trigger of the recognizing processing to an owner of the target picture to indicate the recognizing processing; the dynamic notification comprising a thumbnail of the target picture and the comment information;
wherein the displaying processing is performed after the thumbnail is clicked.

11. An apparatus for recognizing a target object at a machine side in human-machine interaction, comprising:
a first displaying module, configured to display a target picture;
a graphic tag superimposing module, configured to superimpose a graphic tag on a target object in the target picture according to an instruction sent by a user; and determine a display parameter of the graphic tag;
an identifier information adding module, configured to add identifier information for the graphic tag;
a storage controlling module, configured to store the display parameter of the graphic tag and the identifier information of the graphic tag in a storage medium related to the target picture; and
a second displaying module, configured to obtain the display parameter of the graphic tag and the identifier information of the graphic tag from the storage medium related to the target picture; display the graphic tag on the target object in the target picture according to the display parameter of the graphic tag; and
display the identifier information of the graphic tag.

12. The apparatus of claim 11, further comprising:
a comment module, configured to display a comment prompt box; receive comment information submitted by a user having comment permission; store the comment information in the storage medium related to the target picture; and display the comment information in a web page related to the target picture.

13. The apparatus of claim 11, further comprising:
a picture aggregating module, configured to determine whether at least two target pictures are superimposed with graphic tags and identifier information of the graphic tags are identical; if at least two target pictures are superimposed with graphic tags and identifier information of the graphic tags are identical, store or display the at least two target pictures as a category of target pictures, and take the identifier information as identifier information of the category of the target pictures.

14. The apparatus of claim 11, wherein the graphic tag superimposing module further comprises:
a face recognizing module, configured to recognize whether there is a face target object before the instruction sent by the user is received, superimposing a graphic tag on the face target object, if there is the face target object.

15. A non-transitory computer readable storage medium, storing computer program for executing the method as claimed in claim 1.
